(19) United States
(12) Patent Application Publication
(10) Pub. No.: US 2002/0133447 A1
(43) Pub. Date: Sep. 19, 2002

(54) Computerized method and system for formulating stock portfolios

(75) Inventor: Gary J. Mastman, Saratoga, CA (US)

Correspondence Address: NATHAN N KALLMAN, 20900 SARAHILLS DRIVE, SARATOGA, CA, 95070, US

(73) Assignee: Smartfolios, Inc.

(21) Appl. No.: 10/035,292

(22) Filed: Jan. 3, 2002

Related U.S. Application Data
(60) Provisional application No. 60/261,558, filed on Jan. 12, 2001.

(51) Int. Cl. G06F 17/60

(52) U.S. Cl. 705/36

(57) ABSTRACT

A method and system for formulating a stock portfolio employs weighting preset parameters that are applied to a multiplicity of stocks received from a database. The weighted parameters are applied to each stock and a Rating is generated for each of the stocks in the database. The parameters and Rating is used to create a Portfolio of a number of stocks. Selected stocks are purchased if they meet the limits set by selected weighted parameters. When a limit associated with the purchase price is reached for one of the Portfolio stocks, the stock is sold and another stock that meets the criteria for a purchase is added to the Portfolio.

### CROSS-REFERENCE TO RELATED APPLICATION

The present application claims priority from U.S. provisional application No. 60/261,558 filed Jan. 12, 2001, which is incorporated herein by reference.

### FIELD OF THE INVENTION

The invention relates to a method and means for establishing a stock portfolio wherein all of the stocks are selected by a computer program according to predetermined parameters and characteristics.

### BACKGROUND OF THE INVENTION

In recent years, there has been an exponential rise in equity or stock investments by individual investors. Many approaches are available to the individual investor. The individual investor may independently buy or sell stocks based upon publicly available data and using the investor's own judgment. The selection of a stock involves a subjective evaluation that is not always based on solid analysis. Another approach is to invest in a mutual fund wherein all management functions are delegated to a fund manager who decides what stocks to buy or sell without any input from the individual investor. In a way, the investor is investing in the person who manages the fund. A problem is that the fund manager may or may not be successful, and the investor has no control over the manager's actions. Another type of investment is found with exchange traded funds or index funds which comprise groups of stocks that closely follow the index which they represent. These may be good vehicles for an investor but are limited by the index they follow. Separately managed accounts or customized managed accounts are presently in favor with large accumulations of retirement accounts. With such types of accounts, the investment advisor or broker recommends certain stocks for purchase and sale consistent with the investor's needs. Typically they are fee based for a percentage of the assets under management plus brokerage charges incurred. Because they require a large investment of the broker's time, these accounts are restricted to amounts over $500,000, but in some instances may decrease to $100,000 with combined management.

### SUMMARY OF THE INVENTION

According to this invention, a stock portfolio is generated by means of a computer program that employs all or some of a number of fundamental and technical parameters. These parameters comprise (1) earnings growth rate past 3 years, (2) earnings growth rate current year, (3) earnings growth rate estimated next year, (4) earnings growth rate last quarter vs same quarter last year, (5) price earnings ratio estimated next year (P/E), (6) price earnings growth ratio current year (PEG), (7) price earnings growth ratio estimated (PEG), (8) sales growth rate past year, (9) sales more or less than 5 year average, (10) price momentum, (11) capitalization, (12) debt, (13) dividend, (14) computed Rating. The computed Rating (14) is generated by calculating the sum of the parameters (1) through (13) wherein each of the parameters are weighted according to the effect on the value of a stock.

To achieve the programmed calculation, a database is received from an external source that provides parameters (1) through (13) on a daily basis. Each parameter is assigned a weight that is consistently used for all stocks being examined. As a result, a Rating is produced for each stock and the weighted values and assigned parameters are stored in a second database together with the Rating for each stock. Groups of stocks that satisfy minimal Ratings are then filtered from the database of all of the externally received stocks. Preset parameters and limits then determine which stocks should be purchased to create a Portfolio and which stocks need to be sold from the Portfolio. Preferably, a Portfolio comprises a group of ten selected stocks. When one stock from the Portfolio is sold, another stock that meets BUY parameters is purchased to maintain a Portfolio of ten selected stocks. The invention is not limited to a Portfolio of ten stocks but may include more or less than ten stocks that meet the parameters established by this invention.

### DETAILED DESCRIPTION OF THE DRAWINGS

The invention will be described in greater detail with reference to the drawing in which:

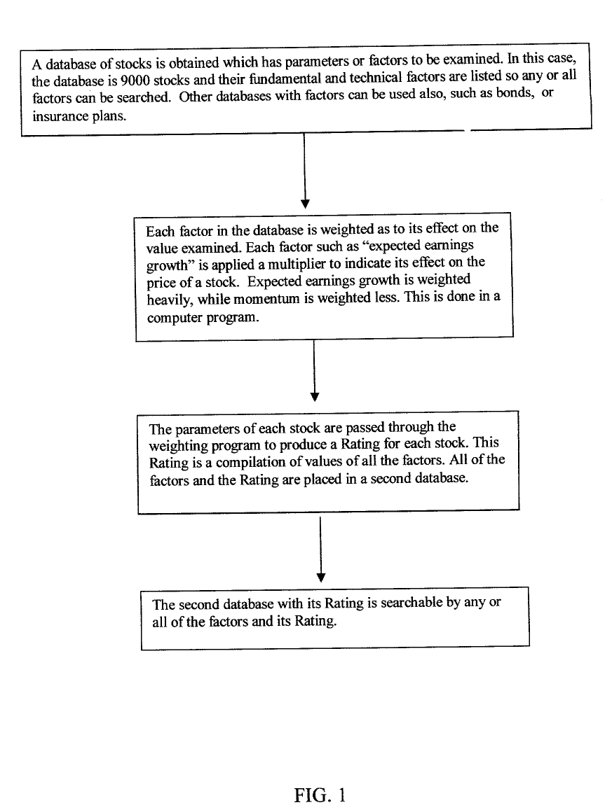

FIG. 1 is a flow chart describing the process of generating a Rating for each of the stocks received from an external data source;

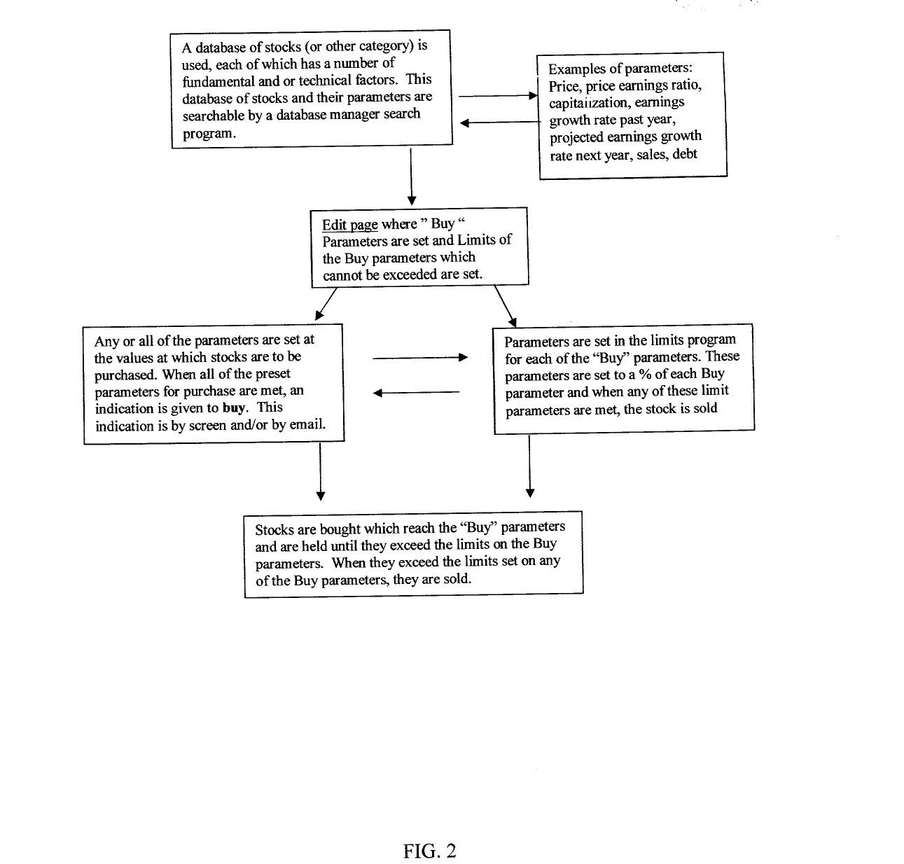

FIG. 2 is a flow chart showing the general process for processing the stocks, in accordance with this invention; and

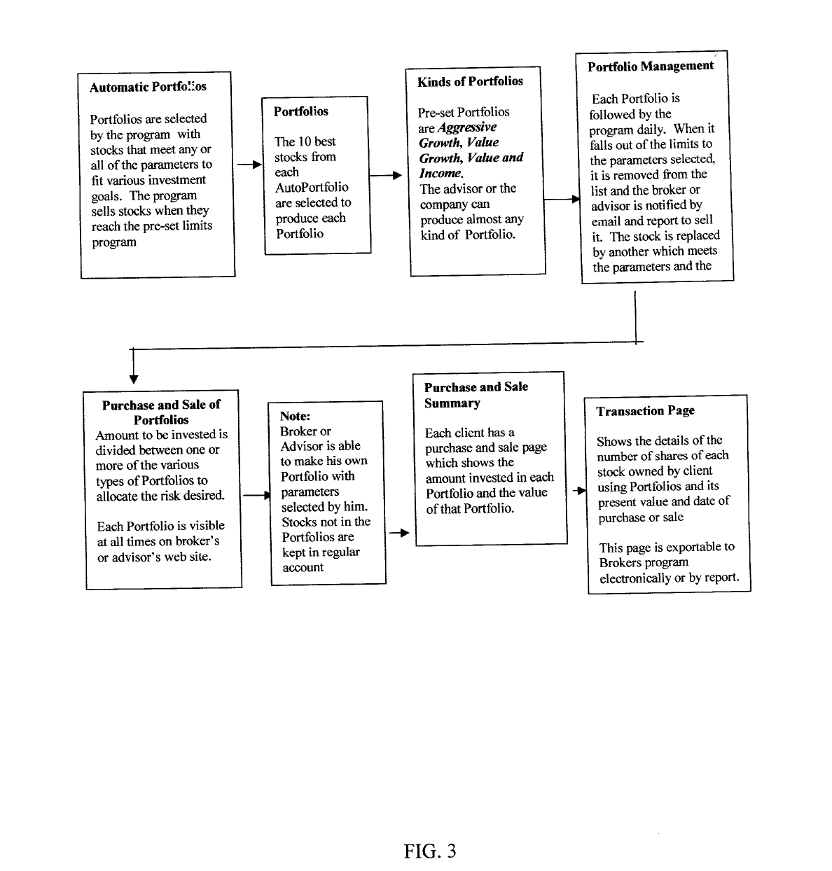

FIG. 3 is a flow chart showing the process for generating a Portfolio with ten stocks that meet the weighted parameters.

### DETAILED DESCRIPTION OF THE INVENTION

With reference to FIG. 1, a database is obtained from an external data source daily via electronic transmission, preferably after the stock market closes each day. The database includes a large number of stocks and fundamental and technical parameters associated with each of the stocks. Typically, the database lists 9000 selected stocks together with the fundamental and technical parameters which may be examined and processed. Each parameter in the database is weighted according to its significance and effect on the price of a stock. Typically, expected earnings growth is weighted heavily, while momentum is weighted at a lower value. The weighting process is implemented by the computer program of this invention and reflects the history of the effects of the parameters on stock prices and stock values. The parameters of each stock are directed through the weighting program to produce a Rating for each stock. This Rating is a compilation of values of all the parameters, and all of the parameters and the Rating are stored in a second database. The second database with Ratings for each stock is searched for any or all of the parameters and the Rating of any stock.

FIG. 2 shows another flow chart in which stocks are selected according to the parameters employed by the present invention. The database of stocks and their parameters are searched by a database manager search program. The parameters include (S1) earnings growth rate past 3 years; (S2) earnings growth rate current year; (S3) earnings growth rate estimate next year; (S4) earnings growth last quarter compared to same quarter 1 year ago; (S5) P/E, estimated; (S6) P/E Growth, current; (S7) P/E Growth, estimated; (S8) sales growth past 12 months; (S9) difference between sales growth rate from the previous 3 years to the last year; (S10) price momentum; (S11) capitalization; (S12) debt; (S13) dividend; and (S14) Rating.

Using the parameters (S1) through (S14), “BUY” parameters are set and limits of the “BUY” parameters that cannot be exceeded are set by the program. Whenever the preset parameters for a “BUY” are met, an indication or notice is provided to BUY. This indication is transmitted and provided by screen or computer monitor or by e-mail. In the “SELL” program, the limits are set for each parameter at either a percentage or a specific value that must be exceeded before the “SELL” program indicates a “SELL” alert. The set percentage is applied to the value at which a particular stock was purchased. Whenever any of these percentage limit parameters are met, an indication is given to sell the stock. Alternatively, a specific value may be set for a purchased stock to initiate a “SELL” alert. The percentages or the specific values are determined by the user or administrator. In effect, stocks that reach the BUY parameters are bought and are held until a stock exceeds the set percentage limit or specific value at which time the stock is sold.

With respect to FIG. 3 which is a flow chart of a portfolios operation, a plurality of stocks are selected by the program to establish a Portfolio. Each Portfolio includes stocks that meet any or all of the parameters that fit investment goals of the individual investor, the broker or a fund manager. The program serves to sell stocks when they reach preset limits as defined by the program. In a specific implementation of the invention, a Portfolio of ten best stocks are selected from an Autoportfolio established automatically by the program. The Portfolio of ten stocks may be selected for aggressive growth, value growth or value and income. Each Portfolio of ten stocks is followed on a daily basis by the program. When a stock of the Portfolio falls out of the limits of the selected parameters, it is removed from the Portfolio listing and replaced by another stock which meets the parameters of the program. The broker or fund manager or individual inventor is thereby alerted to sell and buy stocks to maintain an active Portfolio.

The amount to be invested is divided between one or more of the various types of portfolios to allocate the risk for the inventor. Each Portfolio is always available and visible at all times on the web site of the broker or investment advisor. The broker or advisor can produce a Portfolio using all or some of the parameters selected from those parameters delineated in the program.

In practice, each client is assigned a purchase and sale page that shows the amount invested in each Portfolio and the value of the Portfolio. In addition, a transaction page shows the details of the number of shares of each stock owned by the client and the present value and date of purchase of sale. This page is obtainable by the broker electronically or by a written report.

The searches may be customized by the broker, advisor or client to use only selected ones of the parameters. In addition, Portfolios can be generated using a set of parameters listed in a previous search. The starting date of the Portfolio is entered and each transaction is shown for stocks that meet or have met the parameters used for evaluation. When a stock falls out of the parameter requirements, the date of such fallout and the gain or loss at the date is shown. When a new stock falls within the parameters of the system, the date of entry is shown. By use of this system, actual past transactions of selected stocks may be observed to learn about past performance.

An example of the determination of weighting for each of the parameters and calculation of the Rating for each stock follows:

CALCULATION OF RATING

| | | Exam- |
|---|---|---|
| | | ple |
| S1 = | EARNINGS GROWTH RATE PAST 3 YEARS | 5 |
| | Growth rate is divided by 4 - if 20% 20% × 100/4 = | |
| S2 = | EARNINGS GROWTH RATE CURRENT YEAR | 10 |
| | Growth rate is divided by 4 - if 20% 40% × 100/4 = | |
| S3 = | EARNINGS GROWTH RATE ESTIMATE | 150 |
| | NEXT YEAR | |
| | Growth rate times 5 if 30% × 100 × 5 | |
| S4 = | EARNINGS GROWTH LAST QUARTER VS SAME | 15 |
| | QTR 1 YR AGO | |
| | Growth rate is divided by 2 - if 30% 30/2 = | |
| S5 = | P/E - ESTIMATED - 40 | 25 |
| | If P/E ratio is neg no rating possible | |
| | Otherwise the P/E is subtracted from 40 and that | |
| | number is used | |
| | For example if P/E is 15, 40 - 15 - 25 | |
| S6 = | P/E G - current - 1.5 (price/earnings growth) | .5 |
| | (1.5 - the current P/E G) | |
| | If neg. - it is not used and no calculation is possible | |
| | e.g. if P/E G = 1 1.5 minus 1 = 5 | |
| S7 = | P/E G - ESTIMATED - 1.5 | 2.5 |
| | (1.5 - the current P/E G) * 5 | |
| | If PEG = 1 .5 × 5 = 2.5 | |
| S8 = | SALES GROWTH PAST 12 MONTHS | e.g. 4 |
| | (sales growth percent * 100)/2.5 | |
| S9 = | SALES MORE OR LESS THAN 5 YR AVERAGE | e.g. 5 |
| | (sales growth percent past 12 mo - 3 yr | |
| | average * 100/2.5 | |
| S10 = | PRICE MOMENTUM - 100 | 25 |
| | (price momentum - 100)/2 | |
| | e.g. if 150 = 150 − 100 divided by 2 = 25 | |
| S11 = | CAPITALIZATION (BILLIONS) | 1 |
| | 1 billion = 1 | |
| S12 = | DEPT | −10 |
| | Minus 1 point for each 10% debt (e.g. if 10% debt) | |
| S13 = | DIVIDEND | 20 |
| | Dividends * 1000 e.g. if 2% dividend = .02 × 1000 | |
| S14 = | RATING | 253 |
| | SUM S1:S13 | |

Thus the Rating for a particular stock that meets the above parameters is “253”.

The application of the parameters to a particular stock, Textron, Inc. (TXT) is presented as an example below.

EXAMPLE OF ASSIGNED VALUES

| Name | Textron, Inc. |
|---|---|
| Ticker Symbol | TXT |
| Date | 28-Sep-2001 |
| Current Price Per Share | 32.80 |
| Principal Business | Aerosp & electron/spec |
| | Consum/mach tool/outdr |
| Earnings Growth Rate Past 3 years | −24% |
| Earnings Growth Rate Current Year | 104% |
| Earnings Growth Rate Estimated Next Year | 15% |
| Earnings Growth Rate Last Qtr. Vs Same | −30% |
| Qtr. Last Year | |
| Price Earnings Ratio Current (P/E) | 8.48 |
| Price Earnings Ratio Estimated Next Year | 7.35 |
| (P/E) | |
| Price Earnings Growth Ratio Current Year | 0.08 |
| (P/E G) | |
| Price Earnings Growth Ratio Estimated Next | 0.48 |
| Year (P/E G) | |
| Sales Growth Rate Current Year | 4% |
| Sales Growth Rate Past Year | 8% |
| Price Momentum | 70.00 |
| Capitalization | 4.63 billions |
| Debt Percent | 189% |
| Dividend | 4% |
| Rating | 150.98 |

In an implementation of the invention, a generated Portfolio includes one share of each selected stock. The stocks are monitored daily by computer programs to alert the broker, advisor or investor whether a stock is to be retained, sold or a new stock is to be added to the Portfolio. Multiple units of each Portfolio are purchased in accordance with the total amount to be invested. Different categories of Portfolios may be purchased for each investor to achieve the best risk benefit balance.

It should be understood that all or only some of the parameters defined herein may be selected for generating a Portfolio. Also, the Rating parameter need not be included with other parameters selected by the user of the program. Furthermore, other parameters, such as cash flow, book value and profit margin may be used in conjunction with some or all of the parameters set forth herein.

What is claimed is:

1. A method for formulating a stock Portfolio comprising the steps of:
establishing a database of a multiplicity of stocks;
applying preset parameters for filtering said stocks to form an Autoportfolio of selected stocks;
weighting each of said preset parameters that are applied to each of said selected stocks for generating a Rating for each stock of said Autoportfolio;
applying said weighted parameters including said Rating to said stocks of said Autoportfolio for establishing limits for issuing a BUY order for a selected stock when the preset parameters for purchase are met;
purchasing a predetermined number of the selected stocks which meet the preset parameters to establish a Portfolio;
setting a limit, related to said limits for issuing a BUY order, for selling a purchased stock from said Portfolio and for issuing a SELL order when said limit for selling is met; and
selling said purchased stock from said Portfolio and purchasing another stock which meets said preset parameters.

2. A method as in claim 1, wherein said step of establishing a database includes obtaining said database on a daily basis.

3. A method as in claim 1, wherein the step of weighting employs the parameters of S1) earnings growth rate past 3 years; (S2) earnings growth rate current year; (S3) earnings growth rate estimate next year; (S4) earnings growth last quarter compared to same quarter 1 year ago; (S5) P/E, estimated; (S6) P/E Growth, current; (S7) P/E Growth, estimated; (S8) sales growth past 12 months; (S9) difference between sales growth rate from the previous 3 years to the last year; (S10) price momentum; (S11) capitalization; (S12) debt; (S13) dividend; and (S14) Rating.

4. A system for formulating a stock Portfolio comprising:
a database of a multiplicity of stocks;
means for applying preset parameters to filter said stocks, thereby forming an Autoportfolio of selected stocks;
means for weighting each of said preset parameters that are applied to each of said selected stocks for generating a Rating for each stock of said Autoportfolio;
means for applying said weighted parameters including said Rating to said stocks of said Autoportfolio for establishing limits for issuing a BUY order for a selected stock when the preset parameters for purchase are met;
means for purchasing a predetermined number of the selected stocks which meet the preset parameters to establish a Portfolio;
means for setting a limit, related to said limits for issuing a BUY order, for selling a purchased stock from said Portfolio and for issuing a SELL order when said limit for selling is met; and
means for selling said purchased stock from said Portfolio and purchasing another stock which meets said preset parameters.

5. A system as in claim 4, wherein said means for applying preset parameters comprises selected ones of the parameters of S1) earnings growth rate past 3 years; (S2) earnings growth rate current year; (S3) earnings growth rate estimate next year; (S4) earnings growth last quarter compared to same quarter 1 year ago; (S5) P/E, estimated; (S6) P/E Growth, current; (S7) P/E Growth, estimated; (S8) sales growth past 12 months; (S9) difference between sales growth rate from the previous 3 years to the last year; (S10) price momentum; (S11) capitalization; (S12) debt; (S13) dividend; and (S14) Rating.
